(19) United States
(12) Patent Application Publication
(10) Pub. No.: US 2024/0418172 A1
(43) Pub. Date: Dec. 19, 2024

(54) PERFORMANCE DERATING CONTROL IN A CIRCULATING PUMP

(71) Applicant: GRUNDFOS HOLDING A/S, Bjerringbro (DK)

(72) Inventors: Robert GREVE, Bjerringbro (DK); Kristian ABILDGAARD, Bjerringbro (DK)

(21) Appl. No.: 18/701,510

(22) PCT Filed: Oct. 27, 2022
(86) PCT No.: PCT/EP2022/080120

§ 371 Date: Apr. 15, 2024

(30) Foreign Application Priority Data
Nov. 4, 2021 (DK) PA 2021 70542

(51) Int. Cl. F04D 15/00

(52) U.S. Cl. CPC F04D 15/00; F04D 15/0088

(57) ABSTRACT

The invention relates to a method of controlling a power limit (P) of a circulating pump (1) comprising a critical component (4) and a first temperature sensor (5) arranged and configured to measure the temperature of the critical component. The first temperature sensor may be arranged on top of, below, integrated with, or in the vicinity of the critical component. The method comprises monitoring the temperature (T) of the critical component by use of the first temperature sensor and using an output signal (6) from the first temperature sensor as a first temperature input signal (7) to a controller (8). By use of the controller and based on the first temperature input signal, the power limit of the circulating pump is controlled in accordance with a performance derating curve for the circulating pump. The invention further relates to a system (3) for controlling a power limit of a circulating pump by use of such a method.

### FIELD OF THE INVENTION

The present invention relates to a method of controlling a power limit of a circulating pump comprising a critical component mounted on a printed circuit board of the circulating pump. In particular, it relates to such a method in which the control is based on a temperature measured by a temperature sensor arranged and configured to measure the temperature of the critical component. The invention further relates to a system for controlling a power limit of a circulating pump.

### BACKGROUND OF THE INVENTION

A circulator pump or circulating pump is a specific type of pump used to circulate gases, liquids, or slurries in a closed circuit. In known electronically controlled circulating pumps, the input power typically has to be restricted in order to ensure that a certain critical temperature is not exceeded which may otherwise cause damage to the various electronic components of the pump or a shut-down of the pump. This restriction of the input power, i.e. the input power limit, is typically determined in consideration of a high temperature of the media being pumped by the pump or a high ambient temperature. Therefore, to obtain a highly reliable product, the worst-case scenario has to be used as the power limit. For some applications, such critically high temperatures may only arise a few times a year or less often.

The circulating pump is rated for continuous operation with a specific load profile in an environment where the media and ambient temperatures are given. A fixed power limit is determined which means that this power limit is always used during operation according to which a predetermined maximum power limit is never exceeded although the actual media and/or ambient temperature might still most of the time be below the limit which might cause damage. Thus, in such applications, the use of a fixed power limit restricts the performance of the pump, and it will be necessary to select a pump which is larger than required for most of the time of operation.

EP 2 857 691 B1 discloses a method of controlling the power limit of a pump, wherein the power limit of the pump is controlled by using a thermal model programmed in the control box on the basis of a pump media temperature Tm and an ambient temperature Ta. With such a method, it is necessary to measure two different temperatures.

Hence, an improved method of controlling a power limit of a circulating pump would be advantageous.

### OBJECT OF THE INVENTION

It is an object of the present invention to provide a method of controlling a power limit of a circulating pump with which a simple and efficient control of the power limit is obtained in a manner that prevents damage or malfunctioning due to an undesired temperature increase within the pump.

It is an object of at least some embodiments of the present invention to provide a method of controlling a power limit of a circulating pump with which a high safety against malfunctioning of the circulating pump is obtained.

It is a further object of the present invention to provide an alternative to the prior art.

In particular, it may be seen as an object of the present invention to provide a method of controlling a power limit of a circulating pump that solves the above mentioned problems of the prior art.

### SUMMARY OF THE INVENTION

The above-described object and several other objects are intended to be obtained in a first aspect of the invention by providing a method of controlling a power limit of a circulating pump comprising a critical component mounted on a printed circuit board of the circulating pump, and
a first temperature sensor arranged and configured to measure the temperature of the critical component, the method comprising:
monitoring the temperature of the critical component by use of the first temperature sensor,
using an output signal from the first temperature sensor as a first temperature input signal to a controller,
by use of the controller and based on the first temperature input signal, controlling the power limit of the circulating pump in accordance with a performance derating curve for the circulating pump while continuing the operation of the circulating pump.

By “critical component” is preferably meant a component which is likely to cause malfunctioning of the pump when the critical component is exposed to a temperature higher than a critical temperature. This critical temperature is typically either predetermined by the supplier of the component itself, or it has been determined as part of the designing of the pump. The malfunctioning of the pump could be due to a malfunctioning of the critical component itself. The determination of a critical temperature does not exclude that a specific critical component could continue to function as normal even above the critical temperature. Different examples of a critical component will be given below.

An increase in temperature will typically be caused by an increase either in the ambient temperature or in the media being pumped by the pump. An increase in temperature may e.g. happen, when the tank of a heating system is being topped-up, since that typically includes switching on an electrical heater to ensure a desired temperature of the liquid in the tank. By measuring the temperature by a temperature sensor specially designed and selected for that purpose, it may be possible to obtain a higher precision in the measurements than what is possible with a determination of the temperature based on read-out of data from traditional temperature sensors of a microprocessor as these have been found not to be precise enough for the present purpose.

The first temperature sensor could e.g. be an NTC sensor or a PTC sensor. However, the scope of protection covers the use of any type of temperature sensor which is suitable for the specific use, e.g. with respect to size and precision.

Within electronics, the term “derating” is the operation of a device at less than its rated maximum capability, typically in order to prolong its life or to avoid damage or malfunctioning. Typical examples include operation below the maximum power rating or current rating. In the present description, the power limit will be used as the parameter to be controlled. However, correspondingly it could be the current limit.

The option of derating of a pump makes it possible to choose a size of a pump dependent on the most often needed power. If the pump occasionally needs to operate under conditions that would otherwise, i.e. without the derating, require a larger pump in order to meet the safety requirements with respect to avoidance of over-heating, the chosen pump can still be used provided that it is safely derated under such conditions.

By designing the pump so that it comprises the components necessary for the control of the power limit, it will be possible to have the whole pump tested and certified by the manufacturer. This is different from alternative solutions based on temperature measurements being performed e.g. in the media being pumped by the pump and/or in the surroundings in which the pump is placed.

The first temperature sensor may be arranged on top of, below, integrated with, or in the vicinity of the critical component. The actual location of the first temperature sensor will be determined in dependence of the available space and of the actual type of sensor used. By arranging the critical component and the first temperature sensor close to each other, a high precision can be ensured.

The first temperature sensor may be arranged in the vicinity of the critical component and connected to an electrical circuit of the printed circuit board. An advantage of having both the critical component and the first temperature sensor connected to the printed circuit board of the pump is that such a pre-assembled unit can be implemented in different types and sizes of pumps without any need for interaction with other parts of the pump. The solution according to the present invention therefore allows for a more efficient manufacturing process than when the mounting of the individual components is to be performed for each pump.

In some embodiments of the invention, the circulating pump is controlled to operate at a nominal power level, Pₙₒₘ, when the temperature of the critical component is below a predefined critical temperature and to switch in a stepwise or continuous manner to a constant or substantially constant lower power level, P_{low}, when the temperature of the critical component reaches or exceeds the critical temperature. The controller may control the pump to switch back to the nominal power level as soon as the temperature of the critical component has decreased to below the critical temperature. “Nominal power level” is defined e.g. in Norm EN16297-1. However, other well-defined ways of defining a nominal power level may also be used in relation to the present invention.

The lower power level may be considered as a second nominal power level which has been predetermined by the manufacturer of the pump and possibly marked on the pump. When this is not the case, it may be determined from the derating curve of the pump as will be shown below in relation to the figures.

In some embodiments of the invention as just described, P_{low}/Pₙₒₘ is in the range of 0.65-0.95, such as in the range of 0.70-0.90, such as is 0.83. An example of such an embodiment will be shown and described in relation to the figures.

The switching between the nominal and lower power levels may take place within 0.1 to 60 seconds, such as within 0.1 to 20 seconds, preferably within 0.1 to 5 seconds. The upper limit of the range is determined by for how long it is still safe to let the pump run above the lower power level without risking damage thereof. This upper limit may therefore depend on the actual pump and be determined as part of the design process.

The first temperature sensor may be arranged within 20 mm from the critical component, such as within 5 mm from the critical component. This distance is typically determined by the smallest distance between the two neighbouring edges of the first temperature sensor and the critical component, respectively.

The critical component may be selected from the following: a relay, an integrated circuit, a frequency converter, and an electrical filter component. These are the components which, during the work leading to the present invention, have been found as those most relevant to monitor the temperature of in order to ensure a safe and well-functioning operation of the types of pumps being tested. However, the scope of protection also covers other types of components which may be relevant to monitor the temperature of. A non-exhaustive list of such components is: motor winding, CM coil, varistor, Y-cap, resistor, optocoupler, microprocessor, power mosfet, X-cap, diode, fuse, DC link cap, surface of controller, and foil on touch button. The type of first temperature sensor and the arrangement thereof may depend on the type of the critical component. As an example, when the critical component is an integrated circuit, it may comprise a built-in temperature sensor.

In any of the embodiments as described above, the printed circuit board may be arranged in a pump control box comprising the controller. Hereby the critical component as well as possibly also the first temperature sensor can be arranged at a location where it is better protected, e.g. against moisture and impact, than what is the case if they had been arranged at other locations in the pump or in the media being pumped as in prior art solutions.

In some embodiments of the invention, the controller is integrated in the circulating pump. However, the scope of protection also covers embodiments wherein the controller is an external unit. This latter option may e.g. be used when the controller is used for the control of a plurality of pumps and possibly also other elements.

The first temperature input signal received from the first temperature sensor may be the only information about temperature used by the controller in the controlling of the power limit of the circulating pump.

Alternatively, the circulating pump may further comprise at least one second temperature sensor arranged and configured to provide a second temperature input signal containing information about the temperature of the critical component to the controller for use in the controlling of the power limit of the circulating pump. Thus, such a second temperature sensor will typically be arranged in the vicinity of the first temperature sensor. The second temperature input signal may be used for monitoring the output signal from the first temperature sensor. Hereby it can provide a built-in safety as it will be possible e.g. to continuously check that the first temperature sensor follows a predefined expected operation. Hereby appropriate action can be taken, if the first temperature sensor stops working as intended. Otherwise, there would be a risk that a critical temperature increase was not registered so that the pump could be damaged.

In any of the embodiments mentioned above, the power limit of the circulating pump may further be controlled in accordance with a standardized norm.

In a second aspect, the present invention relates to a system for controlling a power limit of a circulating pump by use of a method according to the first aspect of the invention.

Such a system comprises a circulating pump comprising a critical component mounted in a printed circuit board of the circulating pump, and a first temperature sensor arranged and configured to measure the temperature of the critical component. As described above, the temperature of the critical component is monitored by use of the first temperature sensor. The system is configured to use an output signal from the first temperature sensor as a first temperature input signal to a controller. The controller may be integrated in the circulating pump. The controller is configured to, based on the first temperature input signal, control the power limit of the circulating pump in accordance with a performance derating curve for the circulating pump while continuing the operation of the circulating pump.

In such a system, the first temperature sensor may be arranged on top of, below, integrated with, or in the vicinity of the critical component.

The first temperature sensor may be arranged in the vicinity of the critical component and connected to an electrical circuit of the printed circuit board.

In some embodiments of a system, the circulating pump is controlled to operate at a nominal power level, Pₙₒₘ, when the temperature of the critical component is below a predefined critical temperature and to switch in a stepwise or continuous manner to a constant or substantially constant lower power level, P_{low}, when the temperature of the critical component reaches or exceeds the critical temperature.

P_{low}/Pₙₒₘ may be in the range of 0.65-0.95, such as in the range of 0.70-0.90, such as is 0.83.

The switching between the nominal and lower power levels may take place within 0.1 to 60 seconds, such as within 0.1 to 20 seconds, preferably within 0.1 to 5 seconds.

The first temperature sensor may be arranged within 20 mm from the critical component, such as within 5 mm from the critical component.

The critical component may be selected from the following: a relay, an integrated circuit, a frequency converter, and an electrical filter component.

The printed circuit board may be arranged in a pump control box comprising the controller.

The first temperature input signal received from the first temperature sensor may be the only information about temperature used by the controller in the controlling of the power limit of the circulating pump.

The circulating pump may comprise at least one second temperature sensor arranged and configured to provide a second temperature input signal containing information about the temperature of the critical component to the controller for use in the controlling of the power limit of the circulating pump.

In embodiments comprising at least one second temperature sensor, the second temperature input signal may be used for monitoring the output signal from the first temperature sensor.

The first and second aspects of the present invention may be combined. These and other aspects of the invention will be apparent from and elucidated with reference to the embodiments described hereinafter.

### BRIEF DESCRIPTION OF THE FIGURES

The method of controlling a power limit of a circulating pump according to the invention as well as a corresponding system will now be described in more detail with regard to the accompanying figures. The figures show one way of implementing the present invention and is not to be construed as being limiting to other possible embodiments falling within the scope of the attached claim set.

FIG. 1 schematically shows an exploded view of an example of a known circulating pump.

FIG. 2 schematically shows a system for controlling a power limit of a circulating pump.

FIG. 3 shows an example of a performance derating curve of a pump.

FIG. 4 shows two examples of control curves for use in relation to the present invention. FIG. 4.a shows a stepwise shift between a nominal power level and a lower power level. FIG. 4.b shows a continuous shift between a nominal power level and a lower power level.

FIG. 5 shows an example of a hysteresis curve which can be used for the control according to the present invention.

FIG. 6 shows an embodiment of the invention comprising a second temperature sensor.

### DETAILED DESCRIPTION OF AN EMBODIMENT

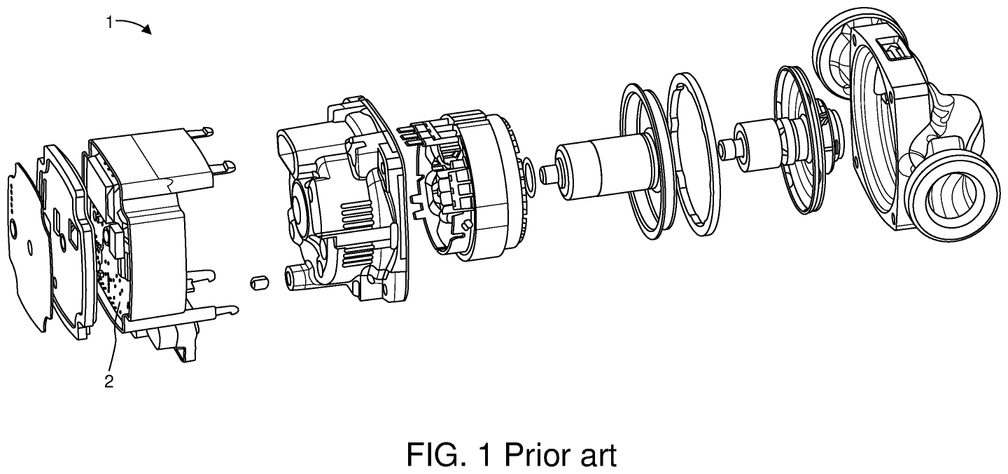

FIG. 1 schematically shows an exploded view of an example of a known circulating pump 1. The different components of which it is composed will be well known to a person skilled in the art. The circulating pump 1 comprises a printed circuit board 2, and a critical component as referred to above will be mounted on the printed circuit board 2.

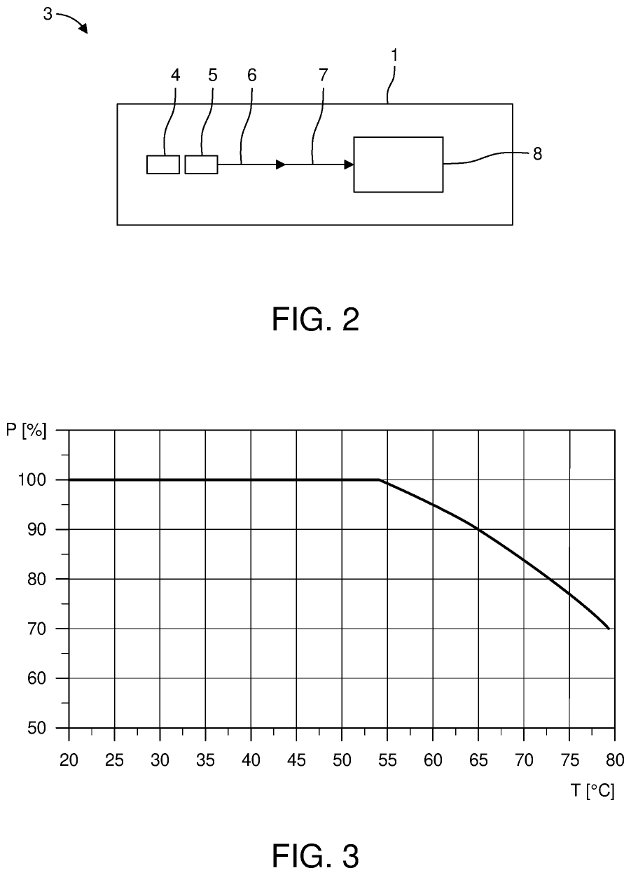

FIG. 2 schematically shows a system 3 for controlling a power limit of a circulating pump 1. The system 3 comprises a circulating pump 1 comprising a critical component 4 and a first temperature sensor 5 which could e.g. be an NTC sensor or a PTC sensor. The critical component 4 may be selected from the following: a relay, an integrated circuit, a frequency converter, and an electrical filter component. However, any component for which it has been found that a temperature thereof could be relevant to monitor and use as an advantageous variable is covered by the scope of the invention. Other examples are given above.

In the embodiment illustrated in FIG. 2, the first temperature sensor 5 is arranged in the vicinity of the critical component 4, but as described above, it could alternatively be arranged on top of, below, or integrated with the critical component 4. The first temperature sensor 5 is typically arranged within 20 mm from the critical component 4, such as within 5 mm from the critical component 4. Which distance to use depends e.g. on the type of temperature sensor used and the precision needed.

The temperature of the critical component 4 is monitored by use of the first temperature sensor 5. An output signal 6 from the first temperature sensor 5 is used as a first temperature input signal 7 to a controller 8. In the embodiment in FIG. 2, the controller 8 is integrated in the circulating pump 1. The controller 8 is configured to, based on the first temperature input signal 7, control the power limit of the circulating pump 1 in accordance with a performance derating curve for the circulating pump 1.

FIG. 3 shows an example of a performance derating curve. In the illustrated example, the power limit P is to be decreased, when the temperature T exceeds 54 degrees Celsius.

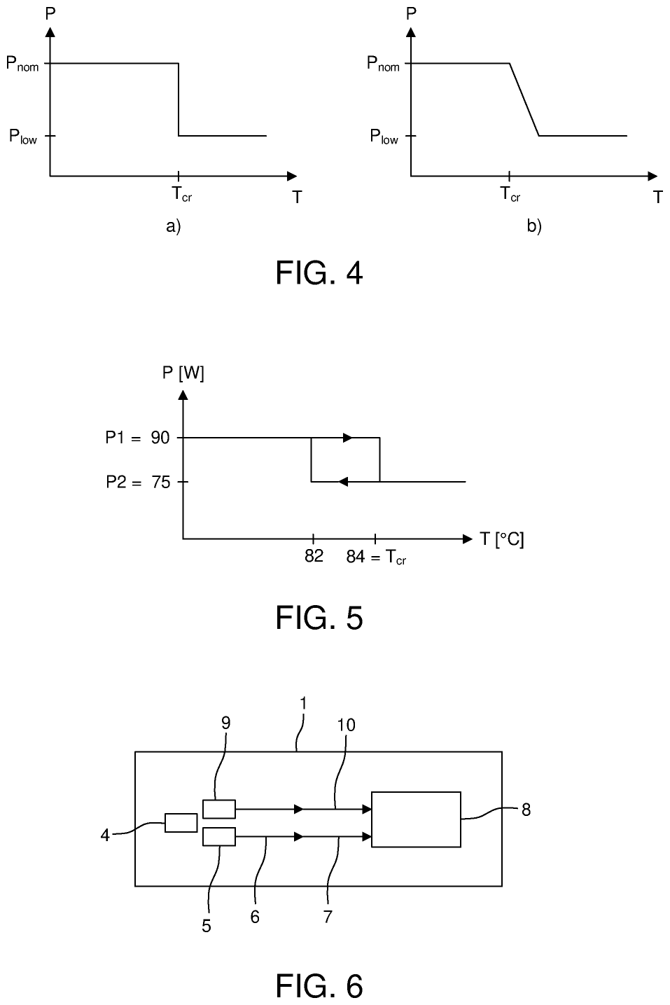

FIG. 4 shows the power limit P of a circulating pump 1 which is controlled to operate at a nominal power level Pₙₒₘ when the temperature T of the critical component 4 is below a predefined critical temperature T_{cr} and to switch to a constant or substantially constant lower power level P_{low}, when the temperature T of the critical component 4 reaches or exceeds the critical temperature T_{cr}. In FIG. 4.a, the switch between the nominal and lower power levels happens in a stepwise manner, and in FIG. 4.b, it happens in a continuous manner with a constant rate of change. The curves may differ from the illustrated ones, such as having more steps or decreasing with a non-constant rate of change. The switching between the nominal and lower power levels typically takes place within 0.1 to 60 seconds, such as within 0.1 to 20 seconds, preferably within 0.1 to 5 seconds. By stepwise is preferably meant within 0.1 to 2 seconds.

FIG. 5 shows an example of a control curve which has been used during the development of the present invention. The tests were performed on a circulating pump 1 having a nominal power level of 90 W and a lower power level of 75 W. The illustrated derating solution is a stepwise reduction from Pₙₒₘ=90 W to P_{low}=75 W when the temperature T of the critical component 4 reached a critical temperature T_{cr}=84° C. When the temperature T had decreased to 82° C., the controller 8 switched the power back to 90 W again. Such a type of control can be referred to as a hysteresis loop.

In the embodiment in FIG. 2, the first temperature input 7 signal received from the first temperature sensor 5 is the only information about temperature used by the controller 8 in the controlling of the power limit of the circulating pump 1. FIG. 6 schematically shows another embodiment in which the circulating pump 1 further comprises a second temperature sensor 9. The second temperature sensor 9 is arranged and configured to provide a second temperature input signal 10 containing information about the temperature of the critical component 4 to the controller 8 for use in the controlling of the power limit of the circulating pump 1. The second temperature input signal is typically used for monitoring the output signal from the first temperature sensor as described above.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Furthermore, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. Method of controlling a power limit (P) of a circulating pump comprising a critical component mounted on a printed circuit board of the circulating pump, wherein the critical component is a relay, and
a first temperature sensor arranged and configured to measure the temperature of the critical component,
the method comprising:
monitoring the temperature (T) of the critical component by use of the first temperature sensor,
using an output signal from the first temperature sensor as a first temperature input signal to a controller,
by use of the controller and based on the first temperature input signal, controlling the power limit of the circulating pump in accordance with a performance derating curve for the circulating pump while continuing the operation of the circulating pump.

2. Method according to claim 1, wherein the first temperature sensor is arranged on top of, below, integrated with, or in the vicinity of the critical component.

3. Method according to claim 1, wherein the first temperature sensor is arranged in the vicinity of the critical component and connected to an electrical circuit of the printed circuit board.

4. Method according to claim 1, wherein the circulating pump is controlled to operate at a nominal power level (Pₙₒₘ) when the temperature (T) of the critical component is below a predefined critical temperature (T_{cr}) and to switch in a stepwise or continuous manner to a constant or substantially constant lower power level (P_{low}), when the temperature of the critical component reaches or exceeds the critical temperature (T_{cr}).

5. Method according to claim 4, wherein P_{low}/Pₙₒₘ is in the range of 0.65-0.95.

6. Method according to claim 4 or 5, wherein the switching between the nominal and lower power levels (Pₙₒₘ, P_{low}) takes place within 0.1 to 60 seconds.

7. Method according to claim 1, wherein the first temperature sensor is arranged within 20 mm from the critical component.

8. (canceled)

9. (canceled)

10. Method according to claim 1, wherein the printed circuit board is arranged in a pump control box comprising the controller.

11. Method according to claim 1, wherein the controller is integrated in the circulating pump.

12. Method according to claim 1, wherein the first temperature input signal received from the first temperature sensor is the only information about temperature used by the controller in the controlling of the power limit of the circulating pump.

13. Method according to claim 1, wherein the circulating pump further comprises at least one second temperature sensor arranged and configured to provide a second temperature input signal containing information about the temperature of the critical component to the controller for use in the controlling of the power limit of the circulating pump.

14. Method according to claim 13, wherein the second temperature input signal is used for monitoring the output signal from the first temperature sensor.

15. Method according to claim 1, wherein the power limit of the circulating pump is further controlled in accordance with a standardized norm.

16. System for controlling a power limit of a circulating pump by use of a method according to claim 1.

17. Method according to claim 5, wherein P_{low}/Pₙₒₘ is in the range of 0.70-0.90.

18. Method according to claim 17, wherein P_{low}/Pₙₒₘ is 0.83.

19. Method according to claim 6, wherein the switching between the nominal and lower power levels (Pₙₒₘ, P_{low}) takes place within 0.1 to 20 seconds.

20. Method according to claim 19, wherein the switching between the nominal and lower power levels (Pₙₒₘ, P_{low}) takes place within 0.1 to 5 seconds.

21. Method according to claim 7, wherein the first temperature sensor is arranged within 5 mm from the critical component.
